(19) United States
(12) Patent Application Publication
(10) Pub. No.: US 2014/0037120 A1
(43) Pub. Date: Feb. 6, 2014

(54) Microphone Assembly

(71) Applicant: Knowles Electronics, LLC, Itasca, IL (US)

(72) Inventors: Tony K. Lim, Naperville, IL (US); Qing Wang, Carol Stream, IL (US); Sandra F. Vos, East Dundee, IL (US)

(73) Assignee: Knowles Electronics, LLC, Itasca, IL (US)

(21) Appl. No.: 13/953,209

(22) Filed: Jul. 29, 2013

Related U.S. Application Data
(60) Provisional application No. 61/678,186, filed on Aug. 1, 2012.

(51) Int. Cl. H04R 23/00

(52) U.S. Cl. CPC H04R 23/00
USPC 381/355

(57) ABSTRACT

A Microelectromechanical system (MEMS) assembly includes a cover, a substrate, at least one wall disposed and between and attached to the cover and the substrate, a MEMS device disposed at the cover and an integrated circuit disposed at the substrate. The integrated circuit and the MEMS device are disposed one over the other and electrically connected together at least in part by conduits that extend through the walls. Alternatively, the MEMS device may be disposed on the substrate and the integrated circuit disposed on the base.

### CROSS REFERENCE TO RELATED APPLICATION

This patent claims benefit under 35 U.S.C. §119 (e) to U.S. Provisional Application No. 61/678,186 entitled “Microphone Assembly” filed Aug. 1, 2012, the content of which is incorporated herein by reference in its entirety.

### TECHNICAL FIELD

This application relates to the acoustic devices and more specifically to the components that are used in these devices.

### BACKGROUND OF THE INVENTION

Various types of acoustic devices have been used over the years. One example of an acoustic device is a microphone and another example is a receiver. Generally speaking, a microphone picks up sound and converts the sound into an electrical signal while a receiver takes an electrical signal and converts the electrical signal into sound.

A microphone typically includes a microelectromechanical (MEMS) device and in some cases an integrated circuit. The MEMS device receives acoustic energy (sound) and converts this into an electrical signal. The MEMS device itself includes a diaphragm and a back plate. Acoustic energy enters through a port in the housing of the assembly. This acoustic energy, in turn, acts to move the diaphragm in the MEMS device, and vary the electrical potential between the back plate and the diaphragm to create an electrical current.

Microphones are used in various applications. For example, microphones are used in hearing instruments (e.g., hearing aids), cellular phones, and personal computers to mention a few examples. The devices in which microphones are deployed have become smaller over time. For instance, the size and weight of cellular phones has been reduced. In order for the size of the overall device to be even further reduced, the size of the microphone needs to be also reduced. Although previous attempts have been made to reduce the size of microphones, these previous attempts have generally encountered limitations as to how much of a reduction could be made without affecting the performance of the microphone.

### BRIEF DESCRIPTION OF THE DRAWINGS

For a more complete understanding of the disclosure, reference should be made to the following detailed description and accompanying drawings herein:

FIG. 1 comprises perspective view of a top port microphone assembly with a MEMS device mounted using a flip-chip configuration according to various embodiments of the present invention;

FIG. 2 comprises a side cutaway diagram of the microphone assembly of FIG. 1 along line A-A according to various embodiments of the present invention;

FIG. 3 comprises a side cutaway diagram of the lid of the microphone assembly of FIGS. 1-2 according to various embodiments of the present invention;

FIG. 4 comprises a view of the lid looking upward with the MEMS not attached of the microphone assembly of FIGS. 1-2 according to various embodiments of the present invention;

FIG. 5 comprises a view of the lid looking upward with the MEMS attached of the microphone assembly of FIGS. 1-2 according to various embodiments of the present invention;

FIG. 6 comprises a view of the base looking downward of the microphone assembly of FIGS. 1-2 according to various embodiments of the present invention;

FIG. 7 comprises a cutaway diagram of a bottom port microphone assembly with a MEMS device mounted using a flip-chip configuration according to various embodiments of the present invention;

FIG. 8 comprises perspective view of a top port microphone assembly with a MEMS device mounted using a surface mount wire bonding configuration according to various embodiments of the present invention;

FIG. 9 comprises a side cutaway diagram of the top port microphone assembly of FIG. 8 along line A-A according to various embodiments of the present invention;

FIG. 10 comprises a side cutaway diagram of the lid of the microphone assembly of FIGS. 8-9 according to various embodiments of the present invention;

FIG. 11 comprises a view of the lid looking upward with the MEMS not attached of the microphone assembly of FIGS. 8-9 according to various embodiments of the present invention;

FIG. 12 comprises a view of the lid looking upward with the MEMS attached of the microphone assembly of FIGS. 8-9 according to various embodiments of the present invention;

FIG. 13 comprises a view of the base looking downward of the microphone assembly of FIGS. 8-9 according to various embodiments of the present invention;

FIG. 14 comprises a cutaway diagram of a bottom port microphone assembly with a MEMS device mounted using a wire bond configuration according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches described herein, a microphone assembly with a small form factor (e.g., overall assembly dimensions between approximately 1 mm to 3 mm (for one side) or 1² mm to 3² mm (total) for both top and bottom port architectures) is provided. In another aspect, the assembly provided in a layout that is a square (or approximately or substantially a square) in configuration. Other configurations are possible. The small form factor permits the microphone assembly to be used in small devices (e.g., devices where reduced size is desirable) such as cellular phones, hearing instruments, and computers.

In many of these embodiments, a microphone assembly includes a lid that is coupled to a wall portion. The wall is disposed to a base portion. The wall portion includes and defines a cavity formed therein. A port is disposed in one of either the base portion or the lid. A MEMS device and an integrated circuit are disposed in the cavity. One of the MEMS device or the integrated circuit is coupled to the lid. The other of MEMS device and the integrated circuit is coupled to the base portion. The MEMS device and the integrated are separated by a small vertical distance. In other words, the MEMS device and the integrated circuit are disposed one over the other (e.g., in one example both centered along a common vertical axis). Vias formed through the wall portion in part provide electrical connections between the MEMS device and the integrated circuit.

In some aspects, the assembly has a negligible front volume that provides an extremely good flat frequency response. In addition, the assemblies described herein can re-use many, if not all, currently established manufacturing and process capabilities.

In others of these embodiments, a Microelectromechanical system (MEMS) assembly includes a cover, a substrate, at least one wall disposed and between and attached to the cover and the substrate, a MEMS device disposed at the cover and an integrated circuit disposed at the substrate. The integrated circuit and the MEMS device are disposed one over the other and electrically connected together at least in part by conduits that extend through the walls. Alternatively, the MEMS device may be disposed on the substrate and the integrated circuit disposed on the base.

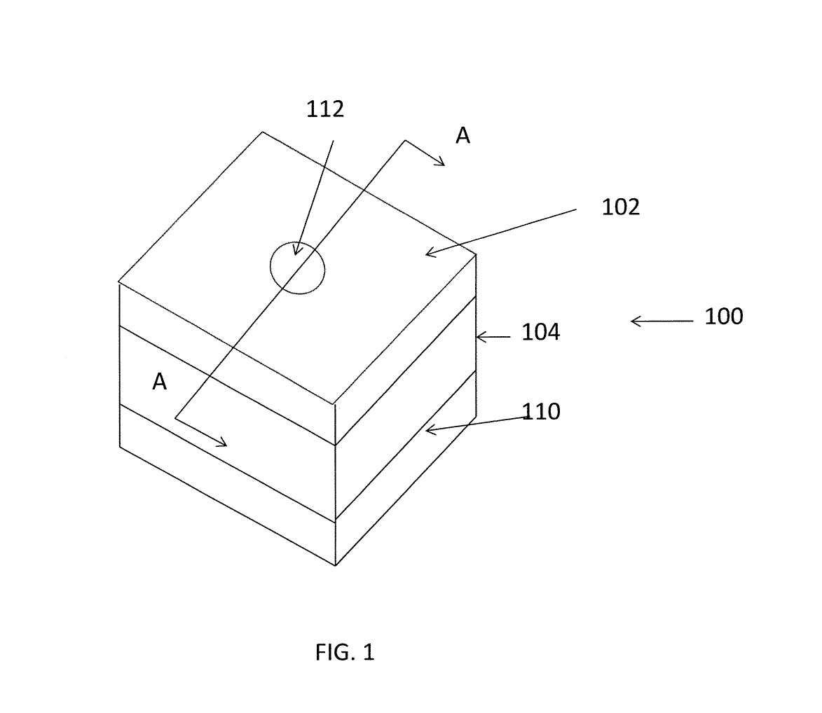

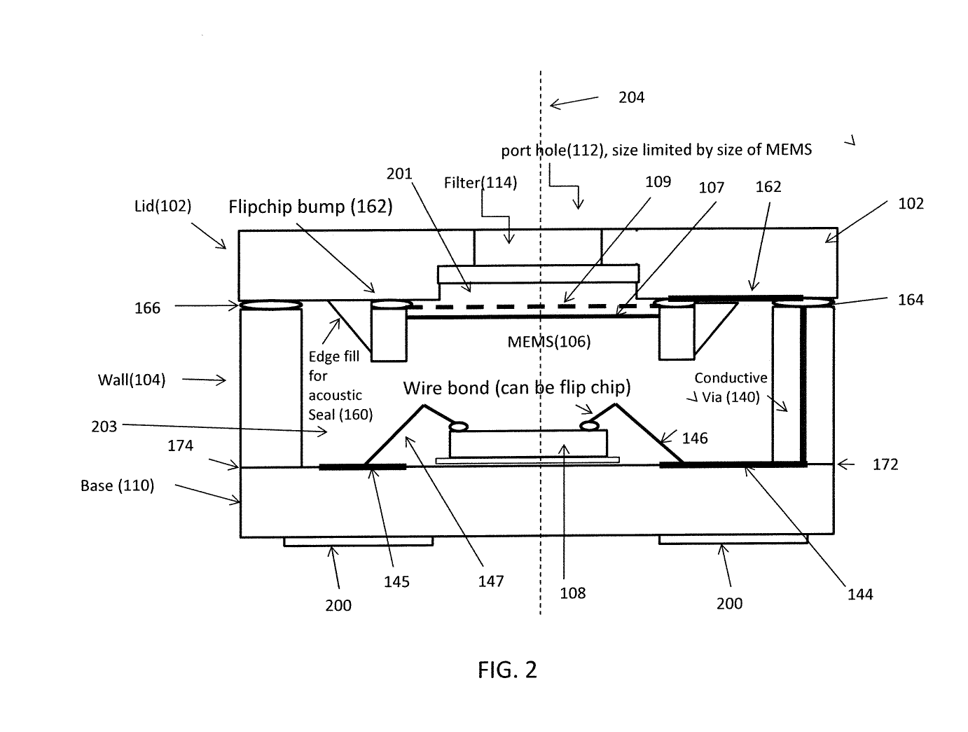

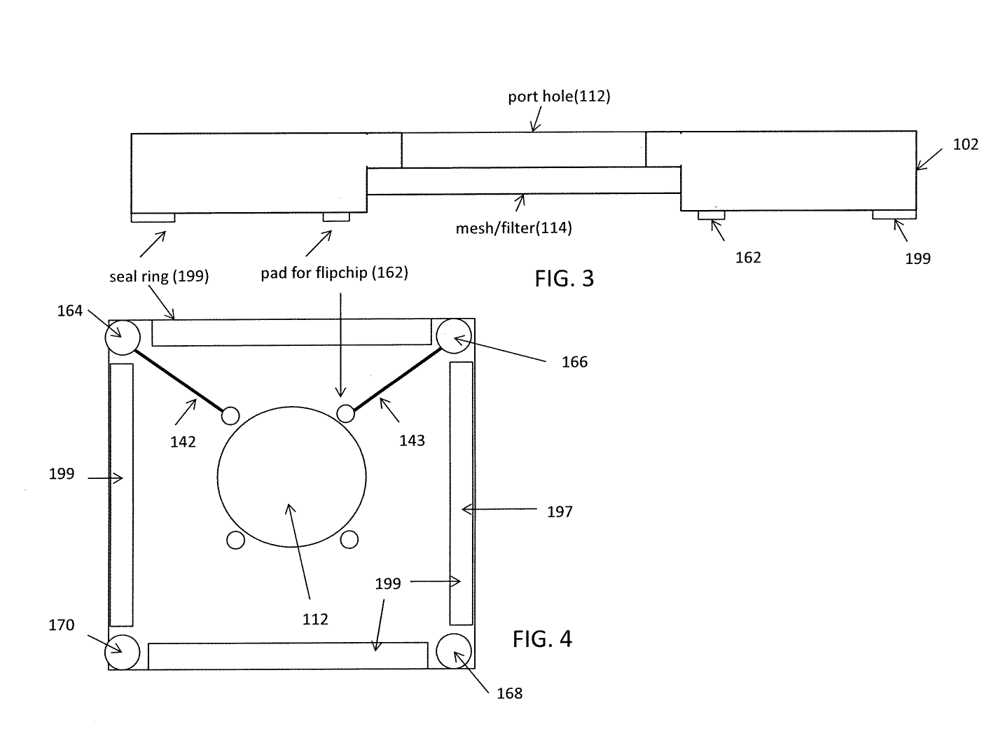

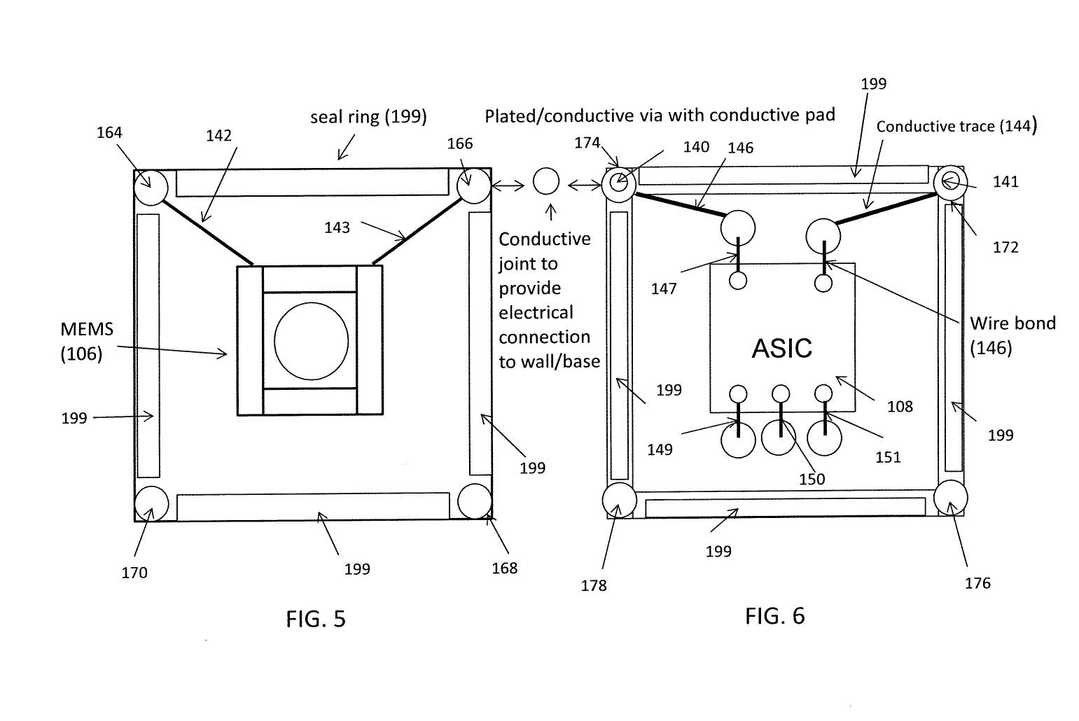

Referring now to FIGS. 1-7, one example of a microphone assembly 100 that includes a top port and uses a flip chip configuration is described. The assembly 100 includes a lid 102, wall portion 104, a MEMS apparatus 106, an integrated circuit 108, and a base 110. Customer contact pads 200 are disposed on the base 110. A top port 112 forms an opening in the lid 102. A particulate filter 114 is disposed in the port 112. One function of the particulate filter 114 is to prevent particles from entering the assembly 100. As used herein “flip chip configuration” means the bond pads of the MEMS device are bonded directly to the substrate material with a conductive interconnect material such as solder bumping or gold-to-gold interface bonding (GGI).

The lid 102 may be a ceramic lid. Other examples of lid construction materials may also be used that allow for the flip chip connection. The base 110 may be a printed circuit board constructed of FR-4 material (or other materials such as ceramic materials).

The wall portion 104 may be constructed in one example of a ceramic and include a first plated via 140 and a second plated via 141. In one aspect, the first and second plated vias 140 and 141 are elongated openings or channels that have been plated or coated with a conductive material (e.g., copper) thereby making the vias conductive to electrical signals. A first trace (or conductor) 142 on the lid 102 electrically couples the MEMS device 106 to the plated via 140. A second trace (or conductor) 143 on the lid 102 electrically couples the MEMS device 106 to the second plated via 141. A first trace (or conductor) 144 on the base 110 couples the via 140 to the integrated circuit 108 (via a wire 146). A second trace (or conductor) 145 on the base 110 couples the second via 141 to the integrated circuit 108 (via wire a 147). Wires 149, 150, and 151 couple the integrated circuit 108 to other traces or conductive paths (not shown) on, and/or through the base 110. These other traces on the base are connected to the customer contact pads 200.

The MEMS apparatus 106 receives sound energy and converts the sound energy into electrical energy. In that respect, the MEMS apparatus 106 may include a diaphragm 107 and a back plate 109. Sound energy causes movement of the diaphragm 107 and this varies the electrical potential between the diaphragm 107 and the back plate 109. Other types of MEMS approaches that do not utilize back plates may also be used. The current or voltage that is produced represents the sound energy that has been received by the MEMS apparatus 106. The MEMS apparatus 106 is attached to the lid 102 by conductive metal connections or any other appropriate fastening mechanism or approach. A front volume 201 and back volume 203 are formed by the assembled assembly.

The integrated circuit 108 is any kind of integrated circuit that performs any kind of processing function. In one example, the integrated circuit 108 is a buffer, application specific integrated circuit (ASIC), or an amplifier. Other examples and types of integrated circuits are possible.

Edge fill 160 is disposed at the MEMS apparatus 106. One purpose of the edge fill 160 is to provide an acoustic seal between the MEMS device 106 and the lid 102 (making the seal to separate the back volume from the front volume). A seal ring 199 acoustically seals the interior of the assembly 100 from the external environment.

Flip chip bumps 162 couple the MEMS device 106 to the lid 102. The flip chip bumps 162 are constructed of an electrically conductive material. Conductive/metal joints 164, 166, 172, and 174 provide an electrical connection between conductor on the lid 102 (or base 110) and the corresponding via 140 or 141. Non-conductive joints 168, 170, 176, and 178 provide are for assembly purposes to enable attachment to all four corners (between the lid 102/wall 104 or base 110/wall 104).

In one example of the operation of the system of FIGS. 1-7, sound energy is received by the MEMS device 106 and the device 106 converts the sound energy into electrical energy. In that respect, the sound energy causes movement of the diaphragm 107 and this varies the electrical potential between the diaphragm 107 and the back plate 109. The current or voltage that is produced represents the sound energy that has been received by the MEMS apparatus 106.

The signal is transmitted from conductor 142, to via 140, to trace 145, to the integrated circuit 108. The integrated circuit 108 may further process the signal and this may be transmitted to further conductors (not shown) in, and/or through the base (via wires 149, 150, and 151) and then from there to pads on the base 200 where a customer may access the pads and signals presented on these pads 200.

It will be appreciated that generally speaking the MEMS device 106 and the integrated circuit 108 are generally stacked or disposed one on top of each other or one over the other. In the examples described herein, the MEMS device 106 and integrated circuit 108 are centered along the same vertical axis 204. However, it will be appreciated that the two devices may be offset from each other (e.g., disposed along different vertical axes). In so doing, the overall from factor or “footprint” of the device can be reduced, for example, resulting in a shape/form factor that is rectangular in shape. In so doing, the overall size of the device is reduced allowing greater miniaturization of devices in which the assembly 100 resides.

Consequently, a microphone assembly with a small form factor (e.g., overall assembly dimensions between approximately 1 mm to 3.0 mm (for one side) or 1² mm to 3² mm (total) for both top and bottom port architectures) is provided. Other examples of dimensions and layouts are possible. It will also be appreciated that there is a small amount of front volume 201 for a flat frequency response. Additionally, for the top port example a back volume 203 (large relative to the front volume) exists for improved signal-to-noise (SNR) performance.

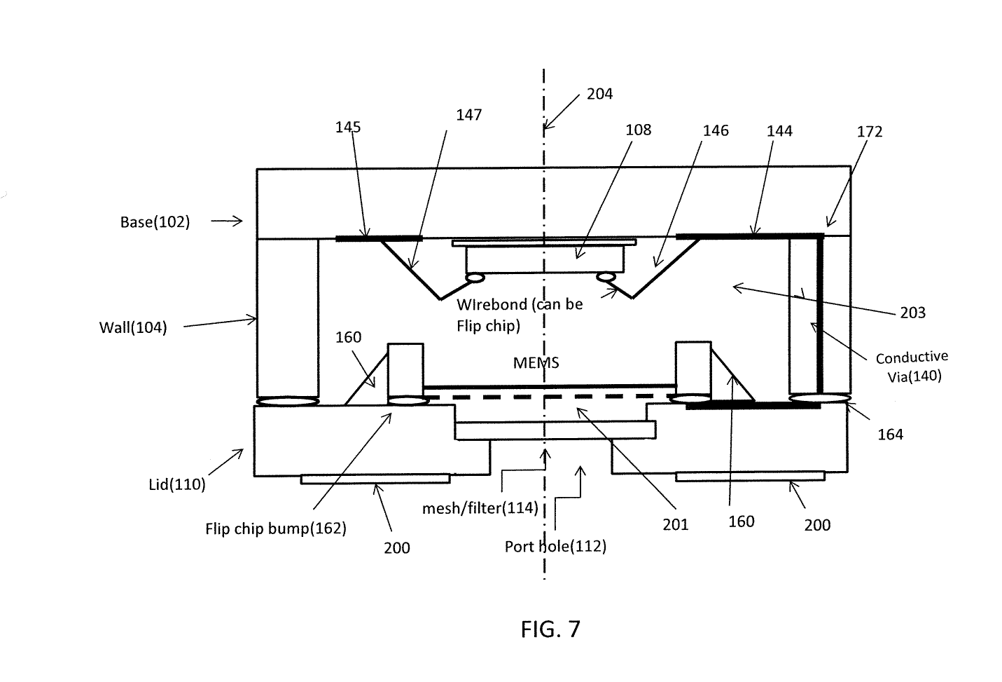

Referring now to FIG. 7, another example of the microphone assembly 100 is described. In this example, the acoustic port is in the base. In this respect, the MEMS device 106 is on the bottom of the assembly (at the base 110) and the integrated circuit 108 is at the top of the assembly (on the lid 102) making this a bottom port configuration. Vias 203 connect the electrical signal from the conductive via 140 to pads 200. The other components are the same as used above in FIGS. 1-7 and there description and operation will not be repeated here. It will be appreciated that the example of FIGS. 1-6 is a top port microphone (with a port opposite the customer solder pads), FIG. 7 illustrates a bottom port device (with a port on same side as the customer solder pads). The two examples are essentially the same assembly rotated 180 degrees except that the customer solder pads are not rotated (they are always on bottom side of the device).

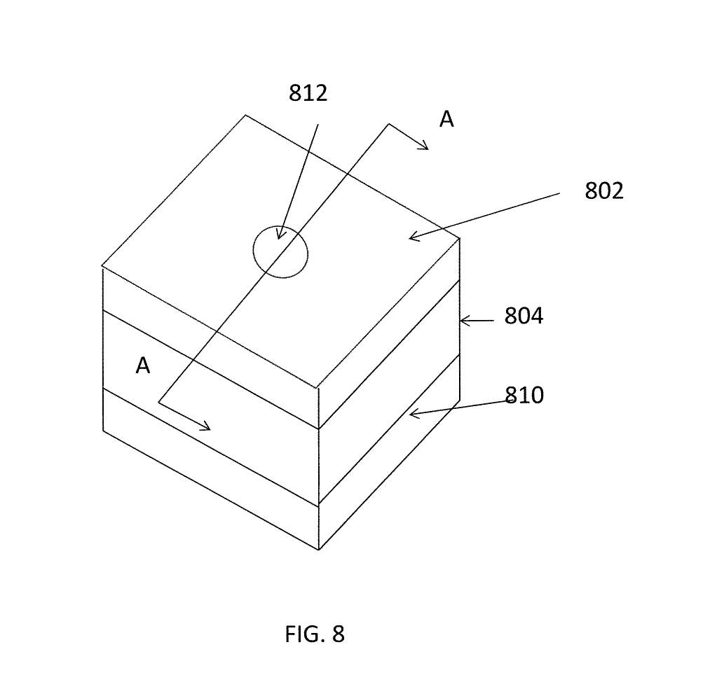

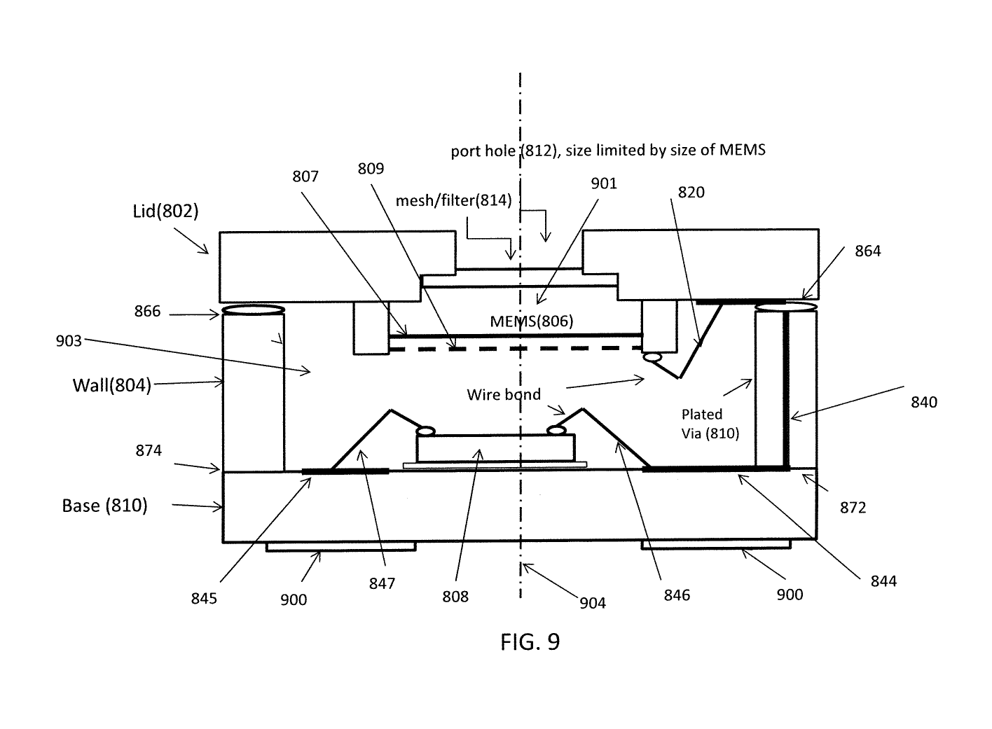

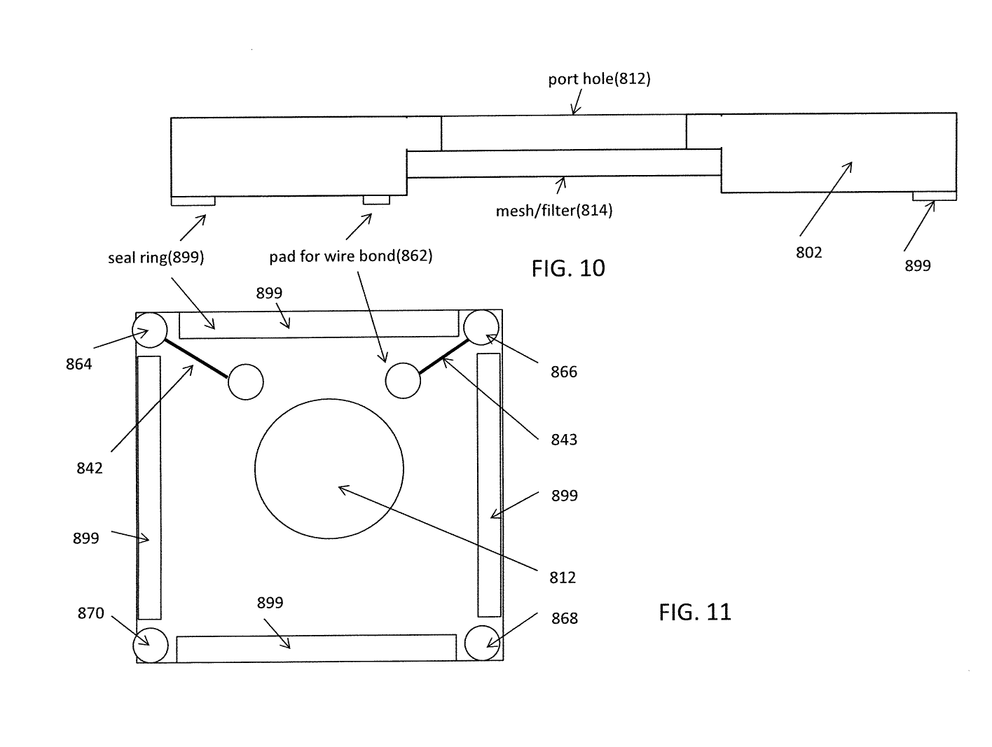

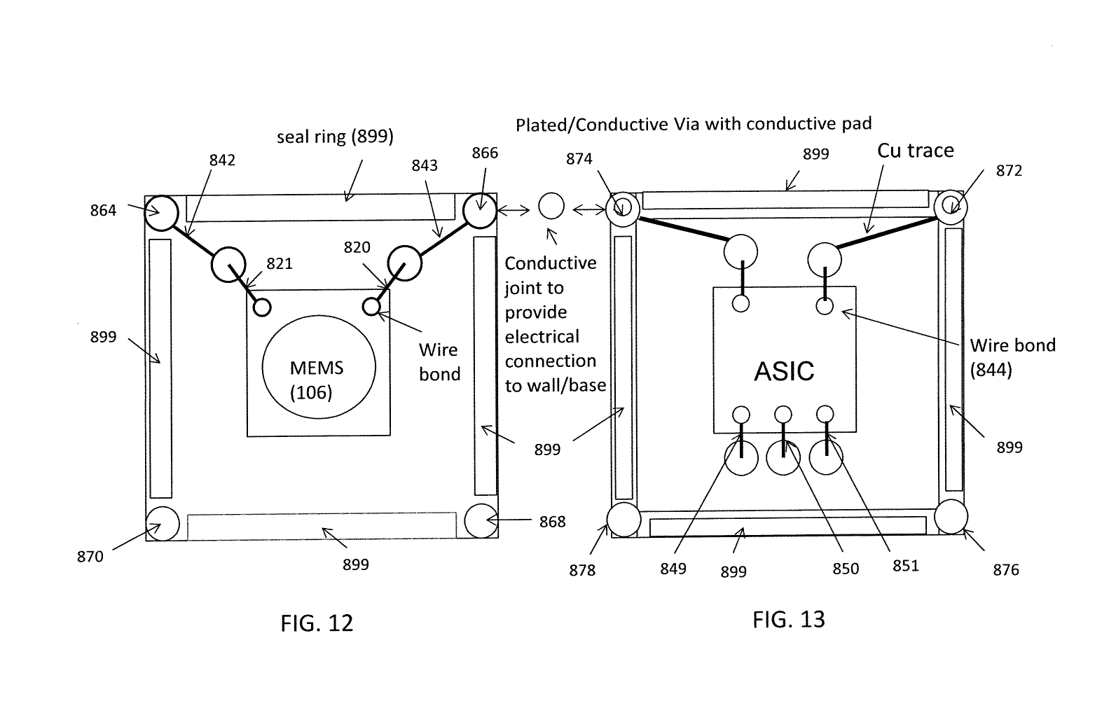

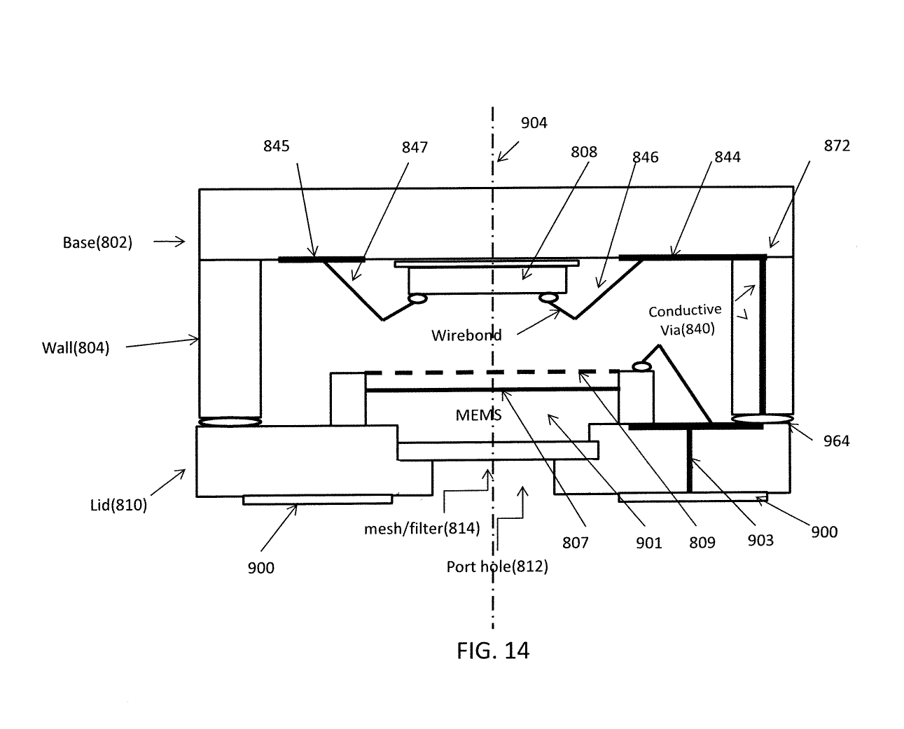

Referring now to FIGS. 8-13, one example of a microphone assembly 800 having a top port with a wire bond configuration is described. This example is similar to the example of FIGS. 1-7 and like-numbered components are numbered in a similar fashion (e.g., the component labeled 102 is labeled 802). A difference between the example assembly 100 of FIGS. 1-7 and the example assembly 800 of FIGS. 8-13 is that the solder bumps 162 are removed (i.e., the MEMS device 106 is not mounted in a flip chip configuration). Instead, the MEMS device is secured to the lid via some fastening approach and electrical connections between the trace 142 (and other traces on the lid 102) and the MEMS device 106 are provided by wire bonds 820 and 821. The operation and other components of the assembly of FIGS. 8-13 are the same as those of the example of FIGS. 1-7 and will not be repeated here.

Referring now to FIG. 14, one example of a microphone assembly having a bottom port with a wire bond configuration is described. In this example, the acoustic port is in the base. In this respect, the MEMS device 806 is on the bottom of the assembly and the integrated circuit 808 is on the top of the assembly making this a bottom port configuration. Vias 903 connect the electrical signal from the conductive via 840 to pads 900. The other components are the same as used above in FIGS. 8-13 and there description and operation will not be repeated here. It will be appreciated that the example of FIGS. 8-13 is a top port microphone (with a port opposite the customer solder pads), FIG. 14 illustrates a bottom port device (with a port on same side as the customer solder pads). The two examples are essentially the same assembly rotated 180 degrees except that the customer solder pads are not rotated (they are always on bottom side of the device).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A Microelectromechanical system (MEMS) assembly comprising:
a cover;
a substrate;
at least one wall disposed and between and attached to the cover and the substrate;
a MEMS device disposed at the cover;
an integrated circuit disposed at the substrate;
such that the integrated circuit and the MEMS device are disposed one over the other and electrically connected together at least in part by conduits that extend through the walls.

2. The MEMS assembly of claim 1 wherein the MEMS device couples to the conduits via electrical conductors at the cover.

3. The MEMS assembly of claim 1 wherein the integrated circuit couples to the conduits via electrical conductors at the substrate.

4. The MEMS assembly of claim 1 wherein the substrate comprises a printed circuit board.

5. The MEMS assembly of claim 1 wherein the cover is constructed of a material comprising a metal or a ceramic.

6. A Microelectromechanical system (MEMS) assembly comprising:
a cover;
a substrate;
at least one wall disposed and between and attached to the cover and the substrate;
a MEMS device disposed at the substrate;
an integrated circuit disposed at the cover;
such that the integrated circuit and the MEMS device are disposed one over the other and electrically connected together at least in part by conduits that extend through the walls.

7. The MEMS assembly of claim 6 wherein the integrated circuit couples to the conduits via electrical conductors at the cover.

8. The MEMS assembly of claim 6 wherein the MEMS device couples to the conduits via electrical conductors at the substrate.

9. The MEMS assembly of claim 6 wherein the substrate comprises a printed circuit board.

10. The MEMS assembly of claim 6 wherein the cover is constructed of a material comprising a metal or a ceramic.
